(19) United States
(12) Patent Application Publication
(10) Pub. No.: US 2003/0220059 A1
(43) Pub. Date: Nov. 27, 2003

(54) Vacuum chuck apparatus

(75) Inventor: Hiromi Yamasaki, Numazu-Shi (JP)

Correspondence Address: PILLSBURY WINTHROP, LLP, P.O. BOX 10500, MCLEAN, VA, 22102, US

(73) Assignee: TOSHIBA KIKAI KABUSHIKI KAISHA, Tokyo-To (JP)

(21) Appl. No.: 10/441,109

(22) Filed: May 20, 2003

(30) Foreign Application Priority Data
May 22, 2002 (JP) 2002-147253

(51) Int. Cl. B25B 11/00

(52) U.S. Cl. 451/388

(57) ABSTRACT

There is provided a vacuum chuck apparatus which eliminates the need to stop machining of a workpiece for cleaning of a filter of the vacuum chuck apparatus and thus enables a long-term continuous operation of a machine tool.

The vacuum chuck apparatus for attracting and holding a workpiece includes: chuck means having a attracting portion for attracting a workpiece onto a contact surface, facing the workpiece, by a vacuum suction force; a negative air pressure source for generating a negative pressure that produces the vacuum suction force at the attracting portion; a first negative pressure supply system for connecting the negative air pressure source to the attracting portion and supplying the negative pressure to the attracting portion; a second negative pressure supply system, connected to the negative air pressure source in parallel with the first negative air supply system, for supplying the negative pressure to the attracting portion; and switch means for selectively switching between the first negative pressure supply system and the second negative pressure supply system.

### BACKGROUND OF THE INVENTION

1. Field of the Invention

The present invention relates to a vacuum chuck apparatus for holding a workpiece by vacuum attraction.

2. Description of Related Art

FIG. 5 shows a circuit diagram of a conventional vacuum chuck apparatus. A workpiece 10 is attracted onto the surface (attracting surface) of a attracting portion 12 of a chuck body. A plurality of suction holes are open at the attracting surface. The suction holes also serve as blowing holes for blowing air. The suction holes are connected, via a rotary joint 42 and a solenoid switch valve 13, to a negative pressure supply system 46 for supplying a negative pressure for air suction and to a positive-pressure air supply system 45 for supplying compressed air that is blew from the suction holes.

The negative pressure supply system 46 is comprised of a compressed air source 41a, a solenoid switch valve 40, a pressure reducing valve 29, a vacuum generator 25, a solenoid switch valve 23, a filter 21, a solenoid switch valve 22, and a solenoid switch valve 13, which are connected in this order downstream of the compressed air source 41a. The piping downstream of the solenoid switch valve 13 is connected to the chuck body via the rotary joint 42. Further, in the air piping for supplying compressed air to the filter 21 for its drainage, a compressed air source 41b, a pressure reducing valve 26 and a solenoid valve 24 are connected in this order, and a piping downstream of the solenoid valve 24 is connected to the filter 21.

The vacuum generator 25 comprises a nozzle 25a (primary side) and a silencer 25b on the air discharge side, which are connected in series. Part of the piping (secondary side) of the negative pressure supply system 46 is joined to the connecting portion. When compressed air is supplied from the primary side, the compressed air injected from the nozzle 25a is expanded, thereby lowering the pressure in the connecting portion. Air flows from the negative pressure supply system 46 on the secondary side into the thus-formed low-pressure region, and the air, together with the flow of the compressed air injected from the nozzle 25a, is discharged to the silencer 25b. In this manner, the air in the negative pressure supply system 46 on the secondary side is sucked in and discharged whereby a negative pressure, which is supplied to the attracting portion 12 of the chuck body, is created.

When attracting the workpiece 10 onto the attracting portion 12 of the chuck body, the solenoid (SOL) 3 of a solenoid valve 14, which is provided in the positive-pressure air supply system 45, is switched off to close the valve. The solenoid (SOL) 10 of the solenoid switch valve 40 is switched on so as to supply compressed air from the compressed air source 41 a to the primary side of the vacuum generator 25, while the solenoid (SOL) 1 of the solenoid switch valve 13, the solenoid (SOL) 5 of the solenoid switch valve 22 and the solenoid (SOL) 8 of the solenoid switch valve 23 are all switched on, whereby the negative pressure supply system 46 opens to the attracting portion 12. Air is thus sucked in from the suction holes formed in the attracting surface of the attracting portion 12 to create a negative pressure, whereby the workpiece 10 is held on the attracting portion 12.

When releasing the workpiece 10 from the attracted state, on the other hand, the solenoid (SOL) 10 of the solenoid switch valve 40 is switched off and the solenoid (SOL) 9 of the valve 40 is switched on, thereby stopping the supply of compressed air to the vacuum generator 25. Further, the solenoid (SOL) 3 of the solenoid valve 14 of the positive-pressure air supply system 45 is switched on to open the valve, while the solenoid (SOL) 1 of the solenoid switch valve 13 is switched off and the solenoid (SOL) 2 of the valve 13 is switched on, so that the negative pressure supply system 46 is closed and the positive-pressure air supply system 45 is opened to the attracting portion 12. Compressed air is thus blew off from the suction holes formed in the surface of the attracting portion 12, whereby the workpiece 10 is released from the attracted state.

When the workpiece 10 is attracted onto the attraction portion 12, in addition to the suction of air from the suction holes formed in the attracting surface, the ambient coolant and cutting chips can also be sucked in. Accordingly, after a repetition of attraction and release of the workpiece 10, the coolant and cutting chips are adhered to a filter element in the filter 21. The coolant, which has accumulated in the filter 21, can be drained away as follows: When the workpiece 10 is not attracted and held on the attracting portion 12, the solenoid (SOL) 4 of the solenoid switch valve 22 is switched on, the solenoid (SOL) 5 of the valve 22 is switched off, the solenoid (SOL) 7 of the solenoid switch valve 23 is switched on and the solenoid (SOL) 8 of the valve 23 is switch off, while the solenoid (SOL) 6 of the solenoid valve 24 is switched on to open the valve 24, whereby compressed air pushes open a check valve 27 provided at the drain outlet of the filter 21, and the coolant can be drained away. On the other hand, unlike the drainage of the coolant in the filter 21, cleaning of the filter 21 cannot be carried out during operation of a machine tool. Further, cleaning of the filter 21 should be carried out periodically so that the filter element is the filter 21 will not be stuffed with the fine cutting chips. Accordingly, a machining operation must be suspended by stopping the machine for cleaning of the filter 21. The filter cleaning thus has been an obstacle to a continuous operation of a machine tool.

### SUMMARY OF THE INVENTION

It is therefore an object of the present invention to provide a vacuum chuck apparatus which eliminates the need to stop machining of a workpiece for cleaning of a filter of the vacuum chuck apparatus and thus enables a continuous operation of a machine tool.

In order to achieve this object, the present invention provides a vacuum chuck apparatus for attracting and holding a workpiece, comprising: chuck means having a attracting portion for attracting a workpiece onto a contact surface, facing the workpiece, by a vacuum suction force; a negative air pressure source for generating a negative pressure that produces the vacuum suction force at the attracting portion; a first negative pressure supply system for connecting the negative air pressure source to the attracting portion and supplying the negative pressure to the attracting portion; a second negative pressure supply system, connected to the negative air pressure source in parallel with the first negative air supply system, for supplying the negative pressure to the attracting portion; and switch means for selectively switching between the first negative pressure supply system and the second negative pressure supply system.

The present invention also provides a vacuum chuck apparatus for attracting and holding a workpiece on a table of a machine tool, comprising: chuck means having a attracting portion for attracting a workpiece onto a contact surface, facing the workpiece, by a vacuum suction force; a negative air pressure source for generating a negative pressure that produces the vacuum suction force at the attracting portion; a first negative pressure supply system for connecting the negative air pressure source to the attracting portion and supplying the negative pressure to the attracting portion; a second negative pressure supply system, connected to the negative air pressure source in parallel with the first negative air supply system, for supplying the negative pressure to the attracting portion; and switch means for selectively switching between the first negative pressure supply system and the second negative pressure supply system.

According to the present invention, the two negative pressure supply systems are connected to the workpiece-attracting portion in parallel and independently. A filter may be provided in each negative pressure supply system. Cleaning of the filter of one of the two negative pressure supply systems can be carried out when that system is in a rest condition, while the other system is switched to an active condition to continue the operation of the vacuum chuck apparatus. Thus, the present invention provides a vacuum chuck apparatus that can clean or change a filter without stopping the machining operating of a machine tool.

### BRIEF DESCRIPTION OF THE DRAWINGS

FIG. 1 is a diagram showing the general construction of a machine tool to which a vacuum chuck apparatus according to the present invention is applied;

FIG. 2 is a circuit diagram of a vacuum chuck apparatus according to an embodiment of the present invention;

FIG. 3 is a circuit diagram of the vacuum chuck apparatus, showing the circuit when the first negative pressure supply system is in an active condition and the second negative pressure supply system is in an inactive condition;

FIG. 4 is a circuit diagram of the vacuum chuck apparatus, showing the circuit when the first negative pressure supply system is in an inactive condition and the second negative pressure supply system is in an active condition; and

FIG. 5 is a circuit diagram of a conventional vacuum chuck apparatus.

### DETAILED DESCRIPTION OF A PREFERRED EMBODIMENT OF THE INVENTION

Preferred embodiments of the present invention will now be described in detail with reference to the drawings.

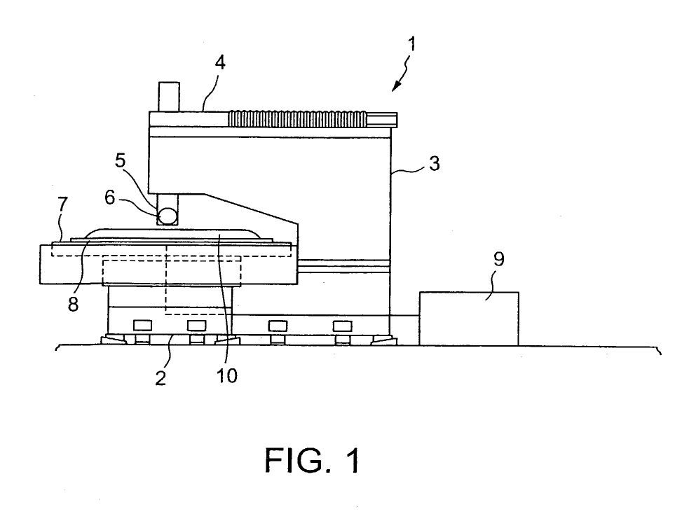

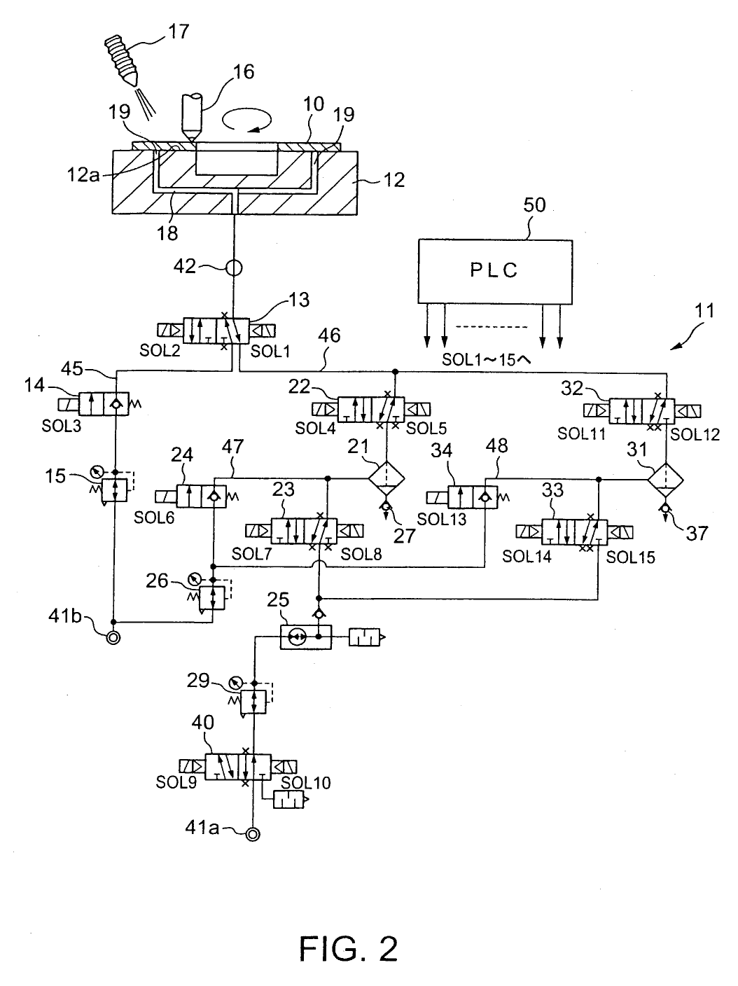

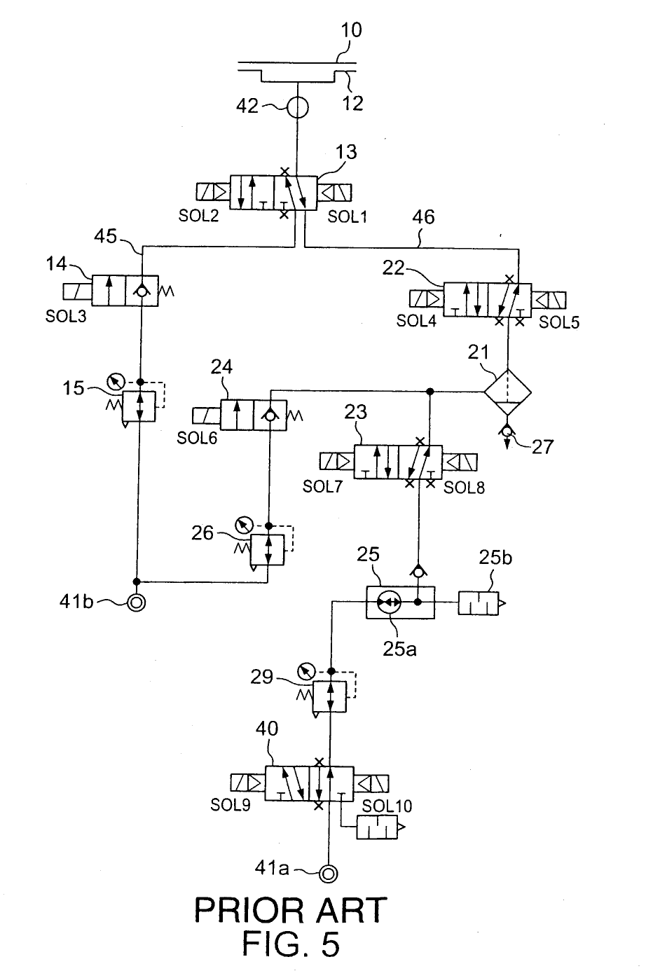

FIG. 1 is a diagram showing the general construction of a machine tool, in which a vacuum chuck apparatus according to the present invention is applied to the rotary table of the vertical lathe. FIG. 2 is a circuit diagram of a vacuum chuck apparatus according to an embodiment of the present invention. In the following description, the same members as in the conventional apparatus shown in FIG. 5 are given the same reference numerals, whereas new reference numerals are given to new or different members.

As shown in FIG. 1, the machine tool 1 is one belonging to a so-called vertical lathe and, according to this embodiment, is used for ultraprecision machining of a workpiece, such as a injection molds for a lens and so on. The machine tool 1 includes a bed 2, a column 3 mounted on the bed 2, a saddle 4 mounted on the column 3, and a ram 5 mounted to the saddle 4 and having a tool post 6. An attracting pad 8, constituting the attracting portion of chuck means, is provided on a rotary table 7. The attracting pad 8 attracts and holds a workpiece 10. In machining operation, the rotary table 7 is rotated while the workpiece 10 is machined by turning it with a cutting tool (not shown) mounted to the tool post 6. Reference numeral 9 denotes a housing in which the air circuit, solenoid valves, etc. of the vacuum chuck apparatus are housed.

FIG. 2 shows an example of the circuit of a vacuum chuck apparatus 11 according to an embodiment of the present invention. In FIG. 2, reference numeral 12 denotes the attracting portion of chuck means, corresponding to the attracting pad 8 of FIG. 1. Reference numeral 16 denotes a cutting tool. The upper surface of the attracting portion 12 constitutes an attracting surface 12a on which the disc-shaped workpiece 10, such as a mold for a lens, is set. Reference numeral 17 denotes a coolant nozzle for spraying a coolant toward the cutting edge of the cutting tool 16 during turning of the workpiece 10 with the cutting tool 16.

In the interior of the body of the attracting portion 12, suction passages 18 extend radially toward the attracting surface 12a. The suction passages 18 turn on its way into suction holes 19 which are open at the attracting surface 12a. The suction passages 18 and the suction holes 19 also serve as air-blowing passages and holes for blowing compressed air to the workpiece 10 when releasing the workpiece 10 from the attracted state.

In FIG. 2, reference numeral 42 denotes a rotary joint for connecting the piping to the attracting portion 12 that rotates together with the rotary table 7. Reference numeral 45 denotes a positive-pressure air supply system for supplying compressed air that is blew from the suction holes 19; 21 denotes a filter; and 25 denotes a vacuum generator for generating a negative pressure. The vacuum generator 25 per se is identical with that shown in FIG. 5.

A negative pressure supply system 46, which supplies the negative pressured generated by the vacuum generator 25 to the attracting portion 12, is comprised of two parallel systems. Thus, a compressed air source 41a (source pressure: 0.6 MPa), a solenoid switch valve 40, a pressure reducing valve 29 and the vacuum generator 25 are connected in this order downstream of the compressed air source 41a. This line branches into two lines downstream of the vacuum generator 25. In one of the two lines, a solenoid switch valve 23, the filter 21, a solenoid switch valve 22 and a solenoid switch valve 13 are connected in this order from the vacuum generator 25, which constitutes a first negative pressure supply system.

The other line constitutes a second negative pressure supply system. The second negative pressure supply system is comprised of a solenoid switch valve 33, a filter 31, a solenoid switch valve 32 and a solenoid valve 13, which are connected in this order from the vacuum generator 25 downstream thereof. The solenoid switch valves 22, 32 are directional control valves for selectively switching to one of the first negative pressure supply system and the second negative pressure supply system. The two negative pressure supply systems are joined on the upstream side of the solenoid switch valves 22, 32, and connected to the solenoid valve 13. The joined negative pressure supply system is connected, via the solenoid switch valve 13 and the rotary joint 42, to the attracting portion 12.

On the other hand, reference numeral 45 denotes a positive-pressure air supply system for supplying compressed air which is blew from the suction holes to release the workpiece 10 from the attracted state. The positive-pressure air supply system 45 is comprised of a compressed air source 41b, a pressure reducing valve 15, a solenoid valve 14 and the solenoid valve 13, which are connected in this order downstream of the compressed air source 41b. The solenoid switch valve 13 thus functions as a directional control valve for switching between the negative pressure supply system 46 and the positive-pressure air supply system 47 to selectively use one of the systems.

In the first negative pressure supply system, an air pipe 47 extending from the compressed air source 41b is connected to the filter 21 for supplying compressed air to the filter 21 for its drainage. A pressure reducing valve 26 and a solenoid valve 24 are provided in the air pipe 47. When the solenoid valve 24 is opened, compressed air is fed through the air pipe 47 to the filter 21 of the first negative pressure supply system, and the compressed air pushes open a check valve 27 at the drain outlet.

Similarly, in the second negative pressure supply system, an air pipe 48 for supplying compressed air to the filter 31 for its drainage, branches off from the air pipe 47 downstream of the pressure reducing valve 26 and extends to the filter 31. A solenoid valve 34 is provided in the air pipe 48. When the solenoid valve 34 is opened, compressed air is fed to the filter 31 of the second negative pressure supply system, and the compressed air pushes open a check valve 37 at the drain outlet.

In FIG. 2, PLC 50 denotes a programmable logic controller, which effects a sequence control of the machine tool 1 and various ancillary equipments according to a previously created sequence program. With respect to the vacuum chuck apparatus, control can be effected on a sequence of switching one of the first and second negative pressure supply systems to an active condition while switching the other system to a rest condition and on a sequence of draining a cutting fluid from the filter of the negative pressure supply system in a rest condition, by switching on and off the solenoids of the respective solenoid valves provided in the first negative pressure supply system, the second negative pressure supply system and the positive-pressure air supply system 45.

The vacuum chuck apparatus of this embodiment has the above-described construction. A description will now be given of the operation and advantages of the apparatus.

[Switching of the First Negative Pressure Supply System to an Active Condition]

When attracting and holding the workpiece 10 on the attracting portion 12 by using the first negative pressure supply system, the PLC 50 effects on/off control of the solenoids of the respective solenoid valves according to the following sequence:

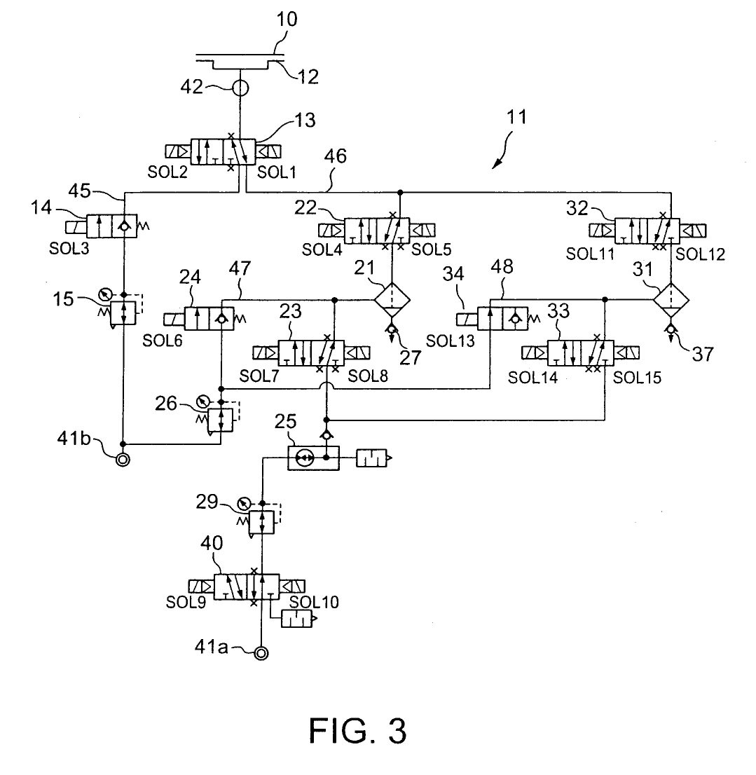

As shown in FIG. 3, the solenoid (SOL) 3 of the solenoid valve 14, provided in the positive-pressure air supply system 45, is off, i.e., the solenoid valve 14 is closed. In order to make the second negative pressure supply system inactive, the solenoid (SOL) 15 of the solenoid switch valve 33 is switched on and the solenoid (SOL) 12 of the solenoid switch valve 32 is switched on. The switching of flow path by the solenoid switch valves 32, 33 closes the flow paths in the second negative pressure supply system.

Next, the solenoid (SOL) 10 of the solenoid switch valve 40 is switched on, thereby switching to the flow path that supplies compressed air from the compressed air source 41a to the primary side of the vacuum generator 25. Further, the solenoid (SOL) 1 of the solenoid switch valve 13, the solenoid (SOL) 5 of the solenoid switch valve 22 and the solenoid (SOL) 8 of the solenoid switch valve 23 are all switched on. By the switching of flow path by the solenoid switch valves, the first negative pressure supply system opens to the attracting portion 12, so that air is sucked in from the suction holes 19, which are open at the attracting surface 12a of the attracting portion 12, to create a negative pressure between the workpiece 10 and the attracting surface 12a, whereby the workpiece 10 is attracted and held on the attracting surface 12a.

[Switching of the Second Negative Pressure Supply System to an Active Condition]

When attracting and holding the workpiece 10 on the attracting portion 12 by using the second negative pressure supply system, the PLC 50 effects on/off control of the solenoids of the respective solenoid valves according to the following sequence:

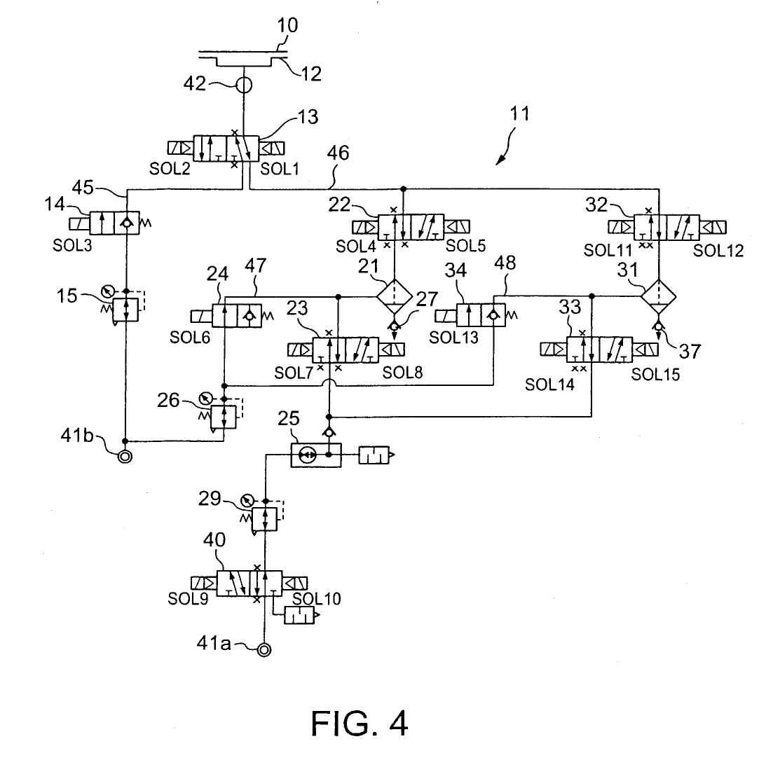

When using the second negative supply system to attract the workpiece 10, as shown in FIG. 4, the solenoid (SOL) 3 of the solenoid valve 14 of the positive-pressure air supply system 45 is off, i.e., the solenoid valve 14 is closed. In order to make the first negative pressure supply system inactive, the solenoid (SOL) 7 of the solenoid switch valve 23 is switched on, the solenoid (SOL) 8 of the valve 23 is switched off, the solenoid (SOL) 4 of the solenoid switch valve 22 is switched on, and the solenoid (SOL) 5 of the valve 22 is switched off.

The solenoid (SOL) 10 of the solenoid switch valve 40 remains on, so that compressed air is supplied from the compressed air source 41a to the primary side of the vacuum generator 25. The solenoid (SOL) 1 of the solenoid switch valve 13, the solenoid (SOL) 14 of the solenoid switch valve 33 and the solenoid (SOL) 11 of the solenoid switch valve 32 are all switched on. By the switching of flow path by the solenoid switch valves, the second negative pressure supply system opens to the attracting portion 12, so that air is sucked in from the suction holes 19, which are open at the attracting surface 12a of the attracting portion 12, to create a negative pressure between the workpiece 10 and the attracting surface 12a, whereby the workpiece 10 is attracted and held on the attracting surface 12a.

[Release of Workpiece]

When releasing the workpiece 10 from the attracted state on the attracting portion 12, the PLC 50 effects on/off control of the solenoids of the respective solenoid valves according to the following sequence. The workpiece release sequence is the same whichever one of the first and second negative pressure supply systems is active.

In releasing the workpiece 10, the solenoid (SOL) 9 of the solenoid switch valve 40 is switched on and the solenoid (SOL) 10 of the valve 40 is switched off, thereby stopping the supply of compressed air from the compressed air source 41a to the vacuum generator 25. Further, the solenoid (SOL) 3 of the solenoid valve 14 of the positive-pressure air supply system 45 is switched on to open the solenoid valve, and the solenoid (SOL) 2 of the solenoid switch valve 13 is switched on and the solenoid (SOL) 1 of the valve 13 is switched off, whereby the positive-pressure air supply system 45 opens to the attracting portion 12. Thus, compressed air is blew from the suction holes 19, which are open at the attracting surface 12a of the attracting portion 12, whereby the workpiece 10 is released from the attracted state.

[Cleaning of Filter]

According to the vacuum chuck apparatus 11 of this embodiment, the negative pressure supply system 46 is comprised of the first negative pressure supply system comprising the filter 21 and the solenoid switch valves 22, 23 and, independent thereof, the second negative pressure supply system comprising the filter 31 and the solenoid switch valves 32, 33. The first and second negative pressure supply systems are provided in parallel by branching the circuit at the exit of the vacuum generator 25. With such a construction, it becomes possible to use one negative pressure system and, on the other hand, clean the filter of the other negative pressure system in a rest condition.

[Cleaning of the Filter of the First Negative Pressure Supply System]

Cleaning of the filter 21 by removal of cutting chips, accumulated in the filter during the use of the first negative pressure supply system, or a change of the filter for a new one, can be carried out after switching the second negative pressure system to an active condition and switching the first negative pressure supply system to an inactive condition in the above-described manner. The internal filter element of the filter 21 is taken out, which is then cleaned or changed.

The coolant filled in the filter 21 can be discharged when the workpiece 10 is not attracted or when the first negative pressure supply system is at rest. Thus, the solenoid (SOL) 4 of the solenoid switch valve 22 is switched on and the solenoid (SOL) 7 of the solenoid switch valve 23 is switched on to thereby close the first negative pressure supply system. Thereafter, the solenoid (SOL) 6 of the solenoid valve 24 in the air pipe 47 is switched on to open the solenoid valve 24, so that compressed air is fed from the compressed air source 41b to the filter 21 and the compressed air pushes open the check valve 27 at the drain outlet, whereby the coolant accumulated can be drained away.

[Cleaning of the Filter of the Second Negative Pressure Supply System]

Cleaning of the filter 31 by removal of cutting chips, accumulated in the filter during the use of the second negative pressure supply system, or a change of the filter element for a new one, can be carried out after switching the first negative pressure system to an active condition and switching the second negative pressure supply system to an inactive condition in the above-described manner. The internal filter element of the filter 31 is taken out, which is then cleaned or changed.

The coolant filled in the filter 31 can be discharged when the workpiece 10 is not attracted or when the second negative pressure supply system is at rest. Thus, the solenoid (SOL) 12 of the solenoid switch valve 32 is switched on and the solenoid (SOL) 15 of the solenoid switch valve 33 is switched on to thereby close the second negative pressure supply system. Thereafter, the solenoid (SOL) 13 of the solenoid valve 34 in the air pipe 48 is switched on to open the solenoid valve 34, so that compressed air is fed from the compressed air source 41b to the filter 31 and the compressed air pushes open the check valve 37 at the drain outlet, whereby the coolant accumulated can be drained away.

As described above, according to the present invention, it becomes possible to make one of the negative pressure supply systems active so that a workpiece can be held by the vacuum chuck apparatus and carry out machining of the workpiece while carrying out cleaning of a filter or draining of a coolant in the other negative pressure supply system in a rest condition. This eliminates the need to stop a machine tool for cleaning of the filter, leading to a remarkably increased machining efficiency. Further, the present invention, when applied to a vertical lathe adapted for ultraprecision machining as in this embodiment, can facilitate cleaning of a filter and prevent the negative pressure supply system from being stained with cutting chips sucked in, making it possible to carry out a high-precision machining efficiently in a clean condition.

What is claimed is:

1. A vacuum chuck apparatus for attracting and holding a workpiece, comprising:
chuck means having a attracting portion for attracting a workpiece onto a contact surface, facing the workpiece, by a vacuum suction force;
a negative air pressure source for generating a negative pressure that produces the vacuum suction force at the attracting portion;
a first negative pressure supply system for connecting the negative air pressure source to the attracting portion and supplying the negative pressure to the attracting portion;
a second negative pressure supply system, connected to the negative air pressure source in parallel with the first negative air supply system, for supplying the negative pressure to the attracting portion; and
switch means for selectively switching between the first negative pressure supply system and the second negative pressure supply system.

2. A vacuum chuck apparatus for attracting and holding a workpiece on a table of a machine tool, comprising:
chuck means having a attracting portion for attracting a workpiece onto a contact surface, facing the workpiece, by a vacuum suction force;
a negative air pressure source for generating a negative pressure that produces the vacuum suction force at the attracting portion;
a first negative pressure supply system for connecting the negative air pressure source to the attracting portion and supplying the negative pressure to the attracting portion;
a second negative pressure supply system, connected to the negative air pressure source in parallel with the first negative air supply system, for supplying the negative pressure to the attracting portion; and
switch means for selectively switching between the first negative pressure supply system and the second negative pressure supply system.

3. The vacuum chuck apparatus according to claim 2, wherein the first negative pressure supply system and the second negative pressure supply system each include filter means for filtering air mixed with a coolant and cutting chips.

4. The vacuum chuck apparatus according to claim 3 further comprising a positive-pressure air supply system for supplying positive-pressure air to the attracting portion to release the workpiece from the attracting portion of the chuck means, and a solenoid valve for switching between connection of the chuck means to one of the first and second negative pressure supply systems and connection of the chuck means to the positive-pressure air supply system, thereby switching the attracting portion between its negative-pressure condition and positive-pressure condition.

5. The vacuum chuck apparatus according to claim 4 further comprising an air pipe for feeding compressed air from the positive-pressure air supply system to the filter means to drain the coolant from the filter means, and a solenoid valve for opening and closing the air pipe.

6. The vacuum chuck apparatus according to claim 4 further comprising control means for controlling a sequence of a process of switching one of the first and second negative pressure supply systems to an active condition while switching the other system to a rest condition, and controlling a sequence of a process of cleaning the filter means of the negative pressure supply system in an inactive condition.

7. The vacuum chuck apparatus according to claim 2, wherein the chuck means is comprised of a attracting pad to be mounted on the rotary table of a vertical grinder.
